(19) United States
(12) Patent Application Publication
(10) Pub. No.: US 2024/0416808 A1
(43) Pub. Date: Dec. 19, 2024

(54) SUPPORT STRUCTURE, SEAT CUSHION STRUCTURE AND CHILD SAFETY SEAT

(71) Applicant: Wonderland Switzerland AG, Steinhausen (CH)

(72) Inventors: Xiaolong MO, Guangdong (CN); Kun ZHANG, Guangdong (CN); Jie WU, Guangdong (CN)

(21) Appl. No.: 18/738,812

(22) Filed: Jun. 10, 2024

(30) Foreign Application Priority Data
Jun. 13, 2023 (CN) 202310702624.7

(51) Int. Cl. B60N 2/28

(52) U.S. Cl. CPC B60N 2/2881

(57) ABSTRACT

The present application provides a support structure, including: a support body; and at least one buffer portion, provided within the support body, where the buffer portion includes a plurality of buffer blocks provided adjacent to each other; where at least one first slit is provided on a support surface of the buffer portion, the first slit divides the buffer portion into the plurality of the buffer blocks, and the plurality of the buffer blocks are connected to each other at at least one position of the buffer portion other than the support surface. The present application further provides a seat cushion structure and a child safety seat.

### CROSS-REFERENCE TO RELATED APPLICATIONS

This application claims priority of Chinese Patent Application No. 202310702624.7, entitled “SUPPORT STRUCTURE, SEAT CUSHION STRUCTURE AND CHILD SAFETY SEAT”, filed on Jun. 13, 2023, the entire content of which is incorporated herein by reference.

### TECHNICAL FIELD

The present disclosure relates to a support structure, a seat cushion structure including the support structure, and a child safety seat including the seat cushion structure.

### BACKGROUND

A child safety seat is a device that is mounted on a car seat and a child is restrained to it by a seat belt. In the event of emergency braking or collision of the car, the child safety seat can effectively prevent the rapid movement of the child's body, avoid secondary collision, reduce the injury to the child, and provide strong protection and restraint for children, so that the safety of the child in the car can be ensured.

In order to adapt to the use of infants and toddlers, existing child safety seats are generally equipped with a seat cushion (or small seat cushion). To enhance the support effect of the seat cushion, a support structure is also provided at the back of the seat cushion to form a seat cushion structure for better support of the child. One problem with existing support structures is that they are unable to provide a good protective effect while providing a supportive effect. More specifically, although the existing seat cushion structures can provide support to the child under normal conditions, the protective effect of the seat cushion structures is not good when the vehicle is subjected to impact. Especially when the seat cushion structure is impacted, it cannot deform enough at the child's back and buttocks, thereby failing to provide better protection for the child's back and buttocks.

To this end, it is necessary to provide a new seat cushion structure that can not only provide support under normal conditions, but also provide sufficient deformation to absorb collision energy when being impacted. In addition, the seat structure needs to have as simple a mechanism as possible in order to facilitate manufacturing and reduce costs.

### SUMMARY

According to a support structure of the present application, the support structure includes: a support body; and at least one buffer portion, provided within the support body, where the buffer portion includes a plurality of buffer blocks provided adjacent to each other; where at least one first slit is provided on a support surface of the buffer portion, the first slit divides the buffer portion into the plurality of the buffer blocks, and the plurality of the buffer blocks are connected to each other at at least one position of the buffer portion other than the support surface.

In an embodiment, the plurality of the buffer blocks are connected to each other at least at a back surface of the buffer portion opposite the support surface.

In an embodiment, the first slit penetrates a back surface of the buffer portion opposite the support surface, and the buffer blocks are connected to each other at a top surface, a bottom surface, a side surface or periphery of the buffer portion.

In an embodiment, the adjacent buffer blocks respectively form cross sections facing and in contact with each other through the first slit.

In an embodiment, the adjacent buffer blocks respectively form cross sections facing each other through the first slit, and a gap exists between adjacent cross sections.

In an embodiment, a plurality of the first slits extend in a longitudinal direction of the support surface and are arranged along a lateral direction of the support surface; or the plurality of the first slits extend in the lateral direction of the support surface and are arranged along the longitudinal direction of the support surface.

In an embodiment, at least one second slit is provided on the support surface, and the second slit intersects the first slit.

In an embodiment, the first slit extends in a longitudinal direction of the support surface, and the second slit extends in a lateral direction of the support surface.

In an embodiment, the first slit extends in an oblique direction of the support surface, and the second slit extends in another oblique direction of the support surface.

In an embodiment, the support body and the buffer portion are integrally formed as a whole.

In an embodiment, a plurality of the buffer portions are provided in parallel within the support body.

In an embodiment, the plurality of the buffer portions are arranged along a longitudinal direction of the support surface, and each of the buffer portions comprises at least one first slit extending along the longitudinal direction of the support surface; or the plurality of the buffer portions are arranged along a lateral direction of the support surface, and each of the buffer portions comprises at least one first slit extending along the lateral direction of the support surface.

In an embodiment, the support body comprises an accommodating portion for accommodating the buffer portion, the accommodating portion penetrates the support body in a direction orthogonal to the support surface, and the support body is of a frame structure.

In an embodiment, the support body extends in a lateral direction and an up-down direction, and the accommodating portion penetrates the support body in a direction orthogonal to the support surface.

In an embodiment, the buffer portion includes the support surface, where a middle portion of the support surface in a longitudinal direction protrudes forwardly, and a bottom end of the support surface is bent forward; a back surface, where the back surface is opposite to the support surface, and a bottom end of the back surface is bent forward; a top surface, where the top surface is inclined backward and downward; a bottom surface, where the bottom surface is opposite to the top surface, the bottom surface is inclined backward and downward, and the bottom surface is larger than the top surface; and two side surfaces, where the two side surfaces are opposite to each other and flat.

In an embodiment, a thickness of the buffer portion at the top surface is less than a thickness of the buffer portion at the bottom surface.

In an embodiment, the buffer block is in a rectangular, square, triangular or rhombic shape.

In an embodiment, a hardness or density of the buffer portion is less than or equal to a hardness or density of the support body.

In an embodiment, a hardness of the buffer portion is between 17 kg/m³ and 29 kg/m³, and a hardness of the support body is between 32 kg/m³ and 40 kg/m³.

In an embodiment, the buffer portion and the support body are made of different materials.

In an embodiment, the buffer portion is made of foam, and the support body is made of memory foam, latex or silicone.

According to a seat cushion structure of the present application, the seat cushion structure includes: a seat cushion; the support structure according to the present application; and a cover member, where the seat cushion is connected to the cover member, and the seat cushion and cover member are located on the support surface of the support structure.

According to a child safety seat of the present application, the child safety seat includes: a seat body including a sitting portion and a backrest portion; and the seat cushion structure according to the present application mounted in a corner portion formed by the sitting portion and the backrest portion.

### BRIEF DESCRIPTION OF THE DRAWINGS

FIG. 1 is a perspective view of a support structure according to a first embodiment of the present application;

FIG. 2 is an exploded perspective view of the support structure;

FIG. 3 is a perspective view of a buffer portion of the support structure;

FIGS. 4A-4C are a bottom view, a top view, and a side view, respectively, of the buffer portion;

FIG. 5 is a perspective view of the support structure according to a second embodiment of the present application;

FIG. 6 is an exploded perspective view of the support structure;

FIG. 7 is a perspective view of the buffer portion of the support structure;

FIG. 8 is a perspective view of the support structure according to a third embodiment of the present application;

FIG. 9 is an exploded perspective view of the support structure;

FIG. 10 is a perspective view of the buffer portion of the support structure;

FIG. 11 is a perspective view of the support structure according to a fourth embodiment of the present application;

FIG. 12 is an exploded perspective view of the support structure;

FIG. 13 is a perspective view of the buffer portion of the support structure;

FIG. 14 is a perspective view of the support structure according to a fifth embodiment of the present application;

FIG. 15 is an exploded perspective view of the support structure;

FIG. 16 is a perspective view of the buffer portion of the support structure;

FIG. 17 shows a perspective view of one buffer portion of a plurality of buffer portions;

FIG. 18 is a perspective view of the support structure according to a sixth embodiment of the present application;

FIG. 19 is an exploded perspective view of the support structure;

FIG. 20 is a perspective view of the buffer portion of the support structure;

FIG. 21 is a perspective view of the support structure according to a seventh embodiment of the present application;

FIG. 22 is a perspective view of the buffer portion of the support structure;

FIG. 23 is a perspective view of the buffer portion of the support structure according to an eighth embodiment of the present application;

FIG. 24 is a perspective view of the support structure according to a ninth embodiment of the present application;

FIG. 25 is a perspective view of a seat cushion structure according to the present application.

### LIST OF REFERENCE SIGNS

100 Support structure
   110 Support body
      111 Side edge
      112 Top edge
      113 Bottom edge
         113a Notch
      114 Accommodating portion
   120 Buffer portion
      121 First slit
      122 Second slit
      123 Support surface
      124 Back surface
      125 Top surface
      126 Bottom surface
      127 Side surface
      128 Periphery
      129 Buffer Block
      DL Depth schematic line
   200 Seat cushion
   300 Cover member
      310 Connector

### DETAILED DESCRIPTION

Although the disclosure is illustrated and described herein with reference to specific embodiments, the disclosure should not be limited to the details shown. Rather, a variety of modifications can be made to these details within the scope of the equivalent solutions of claims and without departing from the present disclosure.

The descriptions of directions such as “forward”, “backward”, “up” and “down” involved in the present disclosure are only for ease of understanding. The present disclosure is not limited to these directions, but may be adjusted according to actual conditions.

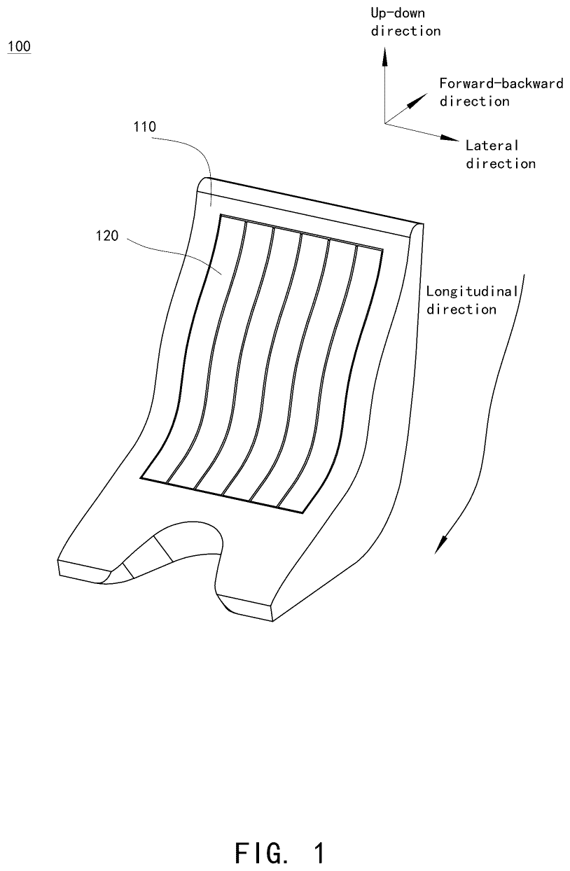

A support structure 100 according to a first embodiment of the present application is described with reference to FIG. 1. The support structure 100 includes a support body 110 and at least one buffer portion 120, where the buffer portion 120 is provided within the support body 110. It should be understood that both the support structure 100 and the buffer portion 120 can provide a supportive effect and a buffering effect.

For ease of description, in the present disclosure, as shown by the direction arrows in FIG. 1, the support structure 100 is described as having an up-down direction, a lateral direction, and a forward-backward direction according to a riding direction of a child safety seat in which the support structure 100 is mounted. The support structure 100 includes a support surface 123 for carrying a child (the support surface 123 of the buffer portion 120 in this embodiment), for example, a surface facing generally forward. In order to adapt to various riding requirements, the support surface 123 may extend in an inclined and/or curved direction. Thus, the extending direction of the support surface 123 is referred to as a longitudinal direction. In this embodiment, the extending direction of the support surface 123 is inclined downward and forward with respect to the up-down direction, and a curved portion protruding forwardly is formed in the middle.

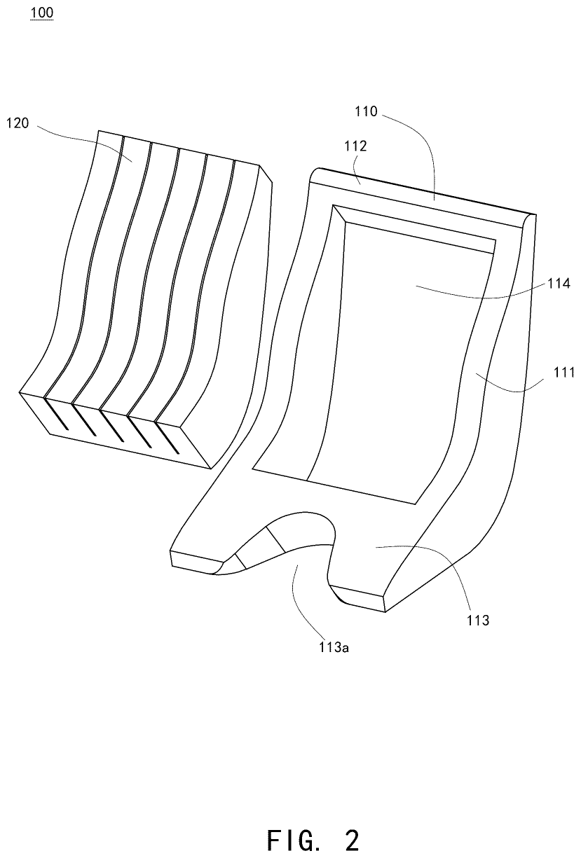

The assembly relationship of the support body 110 and the buffer portion 120 is described with reference to FIG. 2. The support body 110 has a frame structure and includes an accommodating portion 114 for accommodating the buffer portion 120, and the accommodating portion 114 penetrates the support body 110 in a direction orthogonal to the support surface 123. Therefore, the support body 110 is formed into a hollow frame.

In this embodiment, the support body 110 extends in the lateral direction and the up-down direction, and includes a top edge 112, a bottom edge 113, and two side edges 111 connected between the top edge 112 and the bottom edge 113. A notch 113a is provided in the middle of the bottom edge 113, and the notch 113a is recessed into the bottom edge 113 along the forward-backward direction to allow a safety belt or a crotch belt (not shown) to pass through the support body 110. In other embodiments, the notch 113a may not be provided.

The shape of the buffer portion 120 generally corresponds to the shape of the accommodating portion 114, so that the buffer portion 120 is stably mounted in the support body 110.

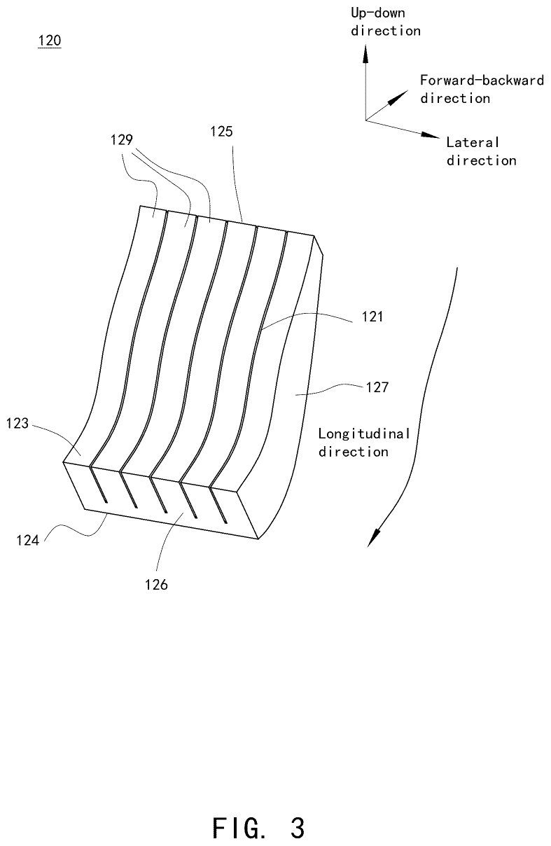

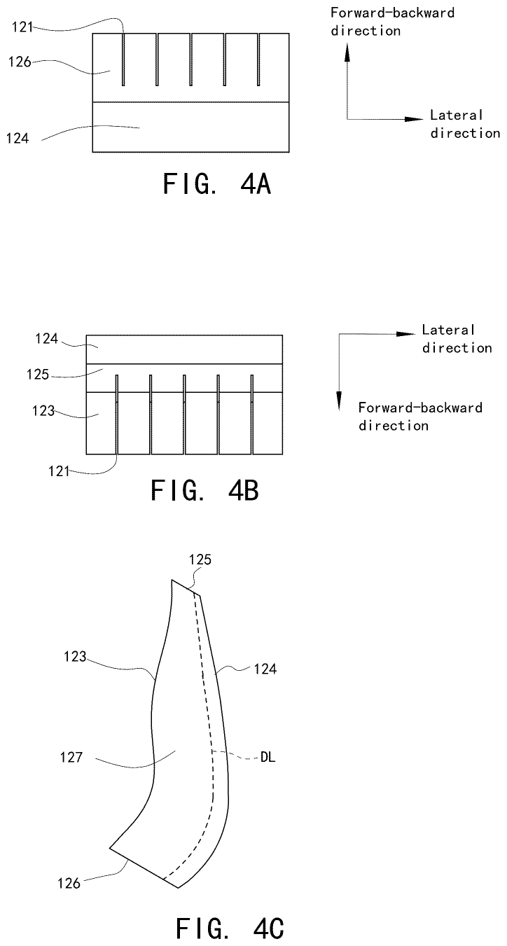

The specific structure of the buffer portion 120 is described with reference to FIGS. 3 to 4C. The buffer portion 120 includes the support surface 123, a back surface 124, a top surface 125, a bottom surface 126 and two side surfaces 127.

More specifically, a middle portion of the support surface 123 in the longitudinal direction protrudes forwardly, and a bottom end of the support surface is bent forward. The back surface 124 is opposite to the support surface 123, and a bottom end of the back surface 124 is bent forward. The top surface 125 is inclined backward and downward. The bottom surface 126 is opposite to the top surface 125, and the bottom surface is inclined backward and downward. The bottom surface 126 may be larger than the top surface 125. Two side surfaces are opposite to each other and (generally) flat. A thickness of the buffer portion 120 at the top surface 125 is less than a thickness of the buffer portion at the bottom surface 126.

It should be understood that the buffer portion 120 may be formed into other appropriate shapes to facilitate a comfortable ride for a child or to adapt to different child safety seats.

The buffer portion 120 includes a plurality of buffer blocks 129 provided adjacent to each other. At least one first slit 121 is provided on a support surface 123 of the buffer portion 120, the first slit(s) 121 divides the buffer portion 120 into the plurality of the buffer blocks 129, and the plurality of the buffer blocks 129 are connected to each other at least one position of the buffer portion 120 other than the support surface 123.

More specifically, a plurality of the first slits 121 extend in the longitudinal direction of the support surface 123 and are arranged along the lateral direction of the support surface 123.

In this embodiment, five first slits 121 are arranged side by side in the lateral direction, thereby dividing the buffer portion 120 into six buffer blocks 129 adjacent along the lateral direction. In other embodiments, more or fewer first slits 121 may be provided.

The plurality of the buffer blocks 129 are connected to each other at least at the back surface 124 of the buffer portion 120 opposite the support surface 123. In this embodiment, as shown in FIG. 4A and FIG. 4B, the first slits 121 penetrate the top surface 125 and the bottom surface 126 of the buffer portion 120. The first slits 121 extend from the support surface 123 toward the back surface 124 but do not penetrate the back surface 124 so that the buffer blocks 129 are connected to each other at the back surface 124. The depth of the first slits 121 may be 50%-90% of the thickness of the buffer portion 120, and the depth ratio may vary along the longitudinal direction. In addition, the depth of each first slit 121 may be different. For example, a first slit 121 in the middle may have a greater depth, and a first slit 121 at the edge may have a smaller depth. Referring to the depth schematic line DL in FIG. 4C, the depth of at least one first slit 121 is schematically illustrated.

In various embodiments of the present application, the first slit 121 may be processed by a CNC computer or a cutting die. That is, a plurality of the buffer blocks 129 may be formed by cutting the entire buffer portion 120. It should be understood that the present application is not limited to such a manufacturing method. The buffer portion 120 with the first slit(s) 121 may be integrally formed by molding, or the buffer portion 120 may be formed by bonding a plurality of the buffer blocks 129.

For ease of understanding, the first slits 121 are drawn with a certain width in FIGS. 3 to 4C. It should be understood that the width shown in the figures does not represent the actual width of the first slits 121.

In various embodiments of the present application, the first slit(s) 121 may have a very small width, so that the adjacent buffer blocks 129 respectively form cross sections facing and in contact with each other through the first slit(s) 121. In this way, the first slit(s) 121 may be virtually invisible in actual use, especially when the buffer block 129 is not deformed. The first slit(s) 121 may also have a certain width, so that the adjacent buffer blocks 129 respectively form cross sections facing each other through the first slit(s) 121, and there is a gap between the adjacent cross sections. In addition, the first slit(s) 121 may have a consistent width in the direction from the support surface 123 to the bottom surface 126, or it may have a varying width, such as being narrower at the support surface 123 and wider near the bottom surface 126.

Since the buffer portion 120 is divided into a plurality of buffer blocks 129 connected to each other, the buffer portion 120 can be easily mounted in the support body and the loss of the buffer portion 120 can be avoided. During normal riding, the support structure 100 has a certain hardness and can support the child's buttocks and back. During emergency braking or collision, each buffer block 129 can provide greater deformation to withstand and disperse the impact force. For example, the buffer blocks 129 located in the middle of the lateral direction where pressure is concentrated can provide greater deformation than the buffer blocks 129 located at the edges, thereby providing better protection for child's buttocks and back.

In comparison, in the situation that the buffer portion 120 is formed as a whole, the buffer portion 120 cannot provide sufficient deformation at the point where pressure is concentrated, and therefore the performance of withstanding and dispersing the impact force is weak. On the other hand, in the case where the buffer portion 120 includes a plurality of buffer blocks 129 that are completely separated from each other, the buffer portion 120 as a whole cannot provide sufficient supporting force.

It should be noted that when a plurality of buffer blocks 129 are connected to each other at the back surface 124, and a gap exists between adjacent sections formed by the first slit 121, if the supporting surface 123 is subjected to a large force, two adjacent sections may be close to be in contact with each other at the supporting surface 123, while a gap is maintained near the connection position. That is, the support structure 100 of the present application not only allows the buffer portion 120 to deform in a direction orthogonal to the support surface 123, but also allows the buffer portion 120 to deform in a direction parallel to the support surface 123, thereby providing a better buffering effect.

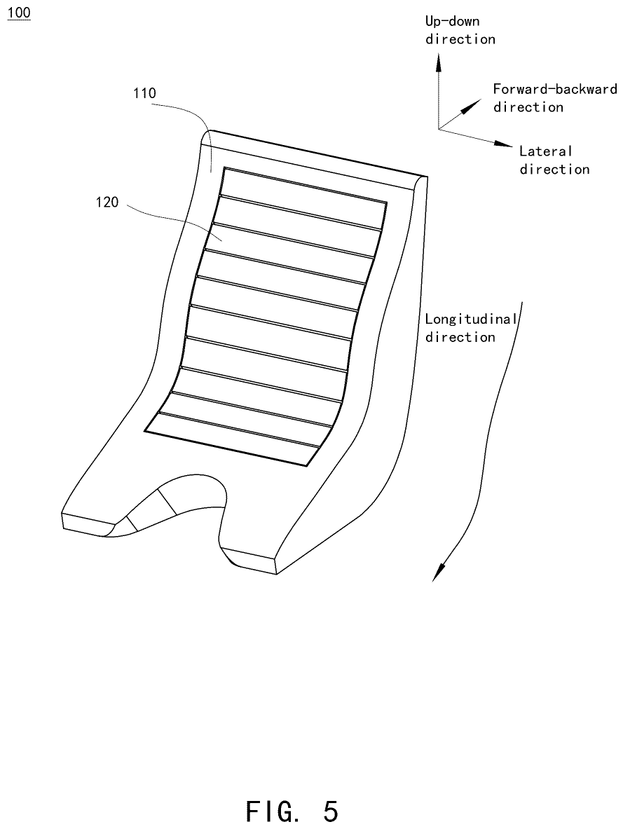

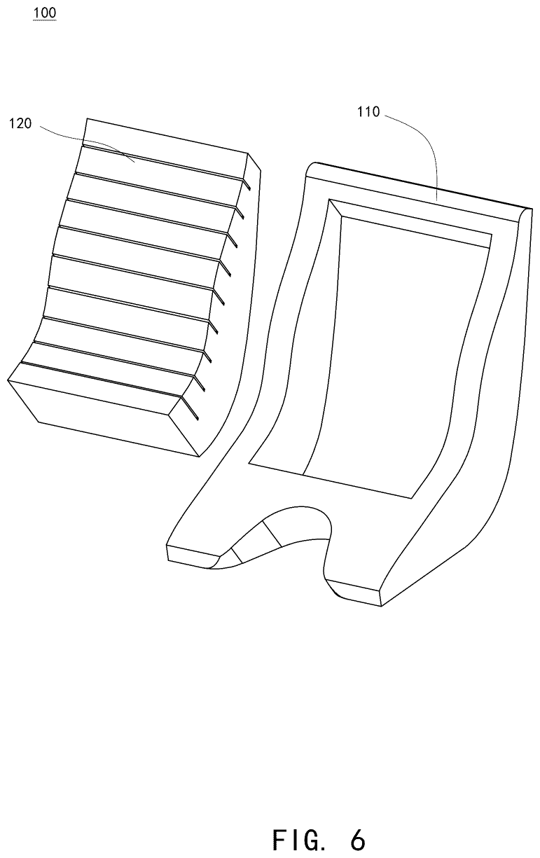

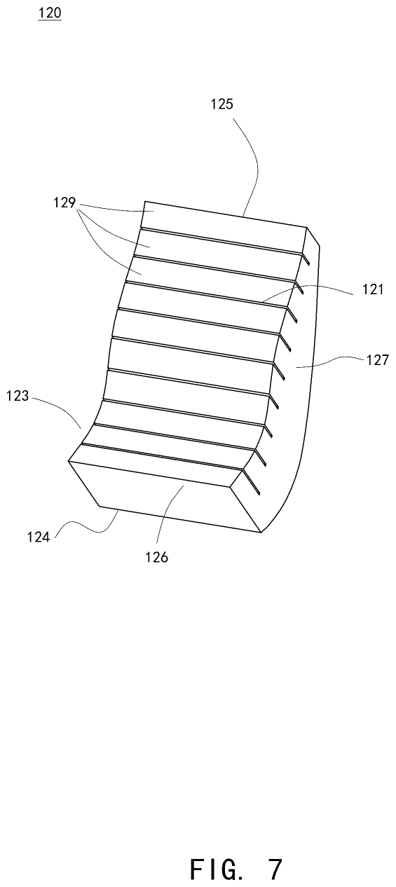

The support structure 100 according to a second embodiment of the present application is described with reference to FIGS. 5 to 7.

The support structure 100 of the second embodiment is substantially the same as that of the first embodiment, and the difference between the two is that the directions of the first slit(s) 121 of the buffer portion 120 are different. In the second embodiment, a plurality of first slits 121 extend in the lateral direction of the support surface 123 and are arranged along the longitudinal direction of the support surface 123. Therefore, the buffer portion 120 includes a plurality of buffer blocks 129 arranged along the longitudinal direction of the support surface 123, and each buffer block 129 is in the shape of a rectangle extending in the lateral direction. In this way, the buffer portion 120 can advantageously disperse the impact force in the longitudinal direction.

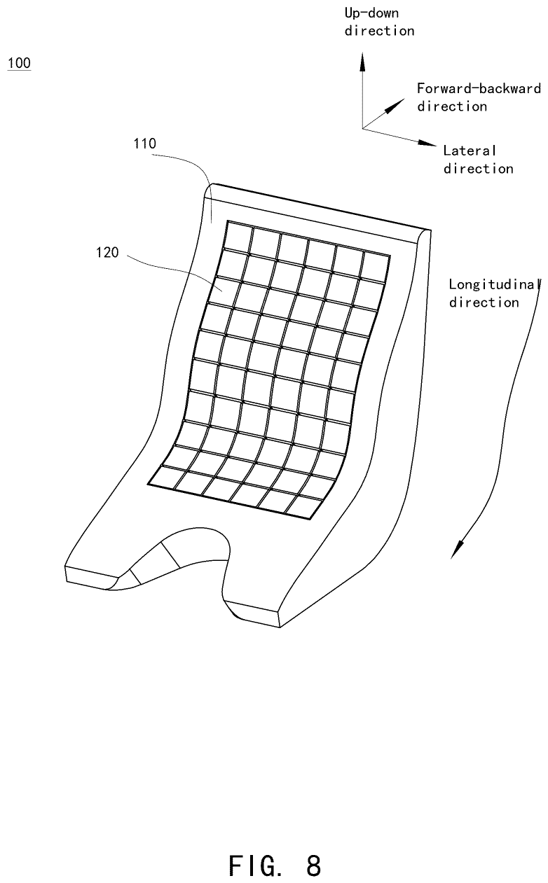

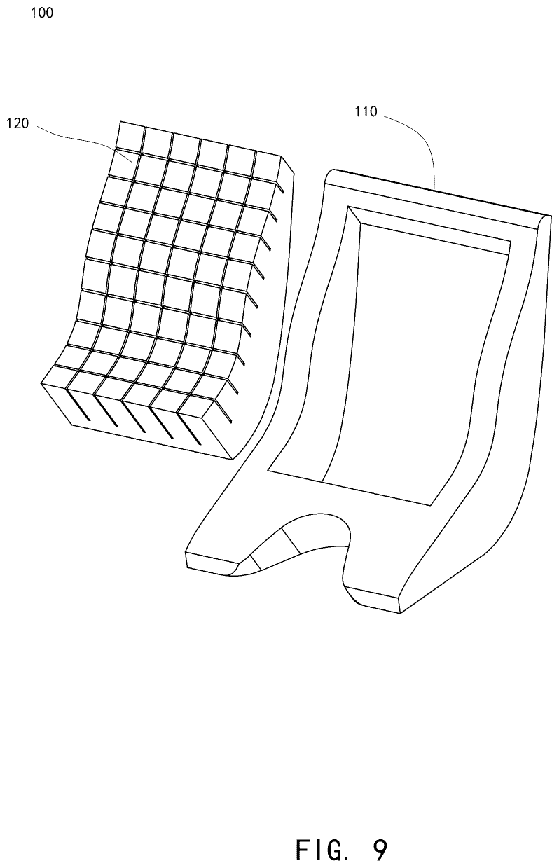

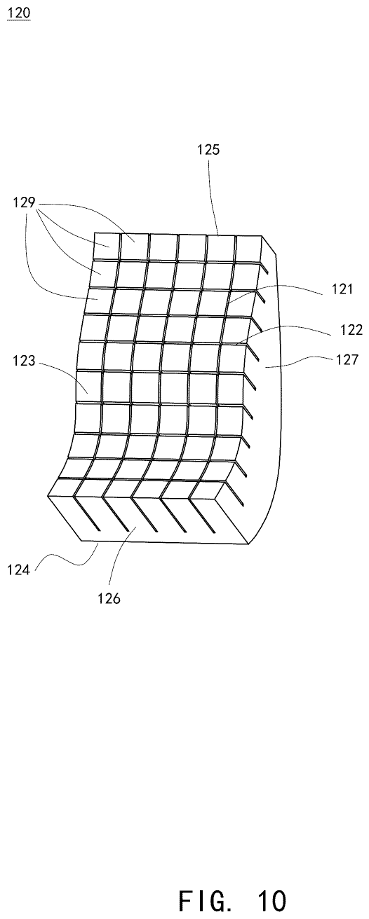

The support structure 100 according to a third embodiment of the present application is described with reference to FIGS. 8 to 10.

The difference between the third embodiment and the first embodiment is that the buffer portion 120 of the third embodiment is divided into a plurality of buffer blocks 129 by at least one first slit 121 and at least one second slit 122. At least one second slit 122 is provided on the support surface 123, and the second slit(s) 122 intersects the first slit(s) 121. The first slit 121 extends in the longitudinal direction of the support surface 123, and the second slit 122 extends in the lateral direction of the support surface 123. Therefore, the buffer portion 120 includes a plurality of buffer blocks 129 arranged in the longitudinal direction and the lateral direction, and each buffer block 129 is substantially square. In this way, the buffer portion 120 can advantageously disperse the impact force in the longitudinal direction and the lateral direction. The plurality of the buffer blocks 129 are also connected to each other at the back surface 124.

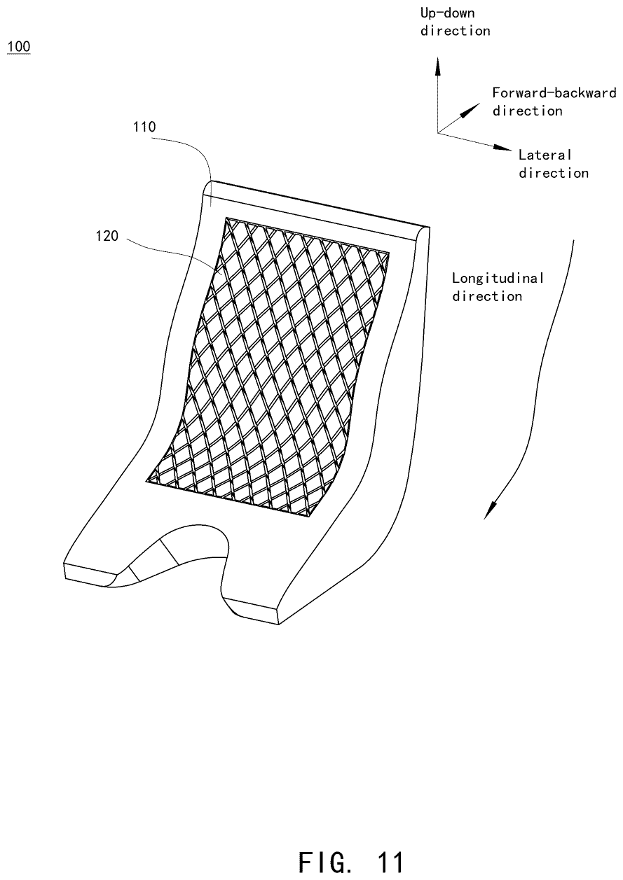

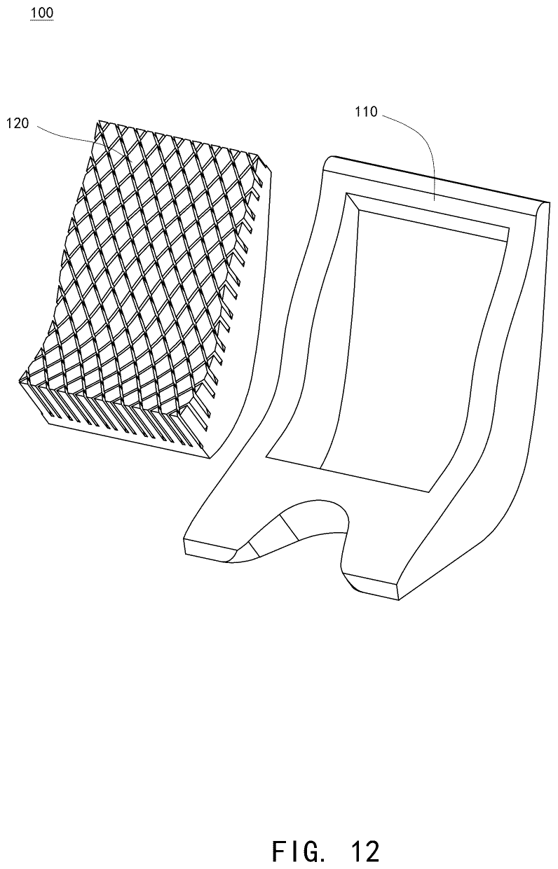

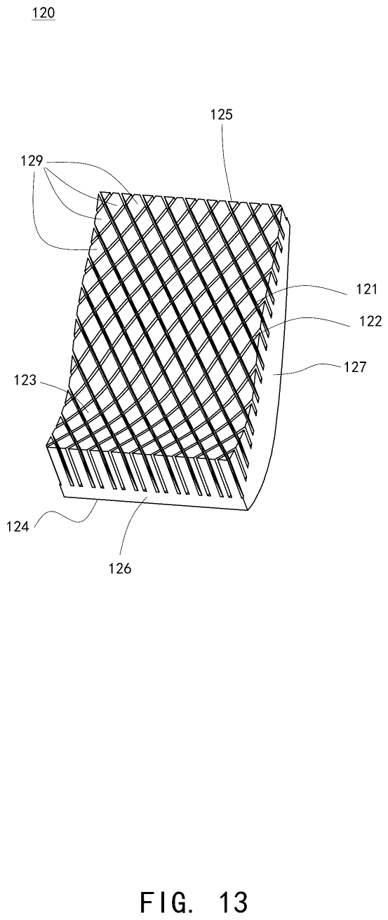

The support structure 100 according to a fourth embodiment of the present application is described with reference to FIGS. 11 to 13.

In the fourth embodiment, the buffer portion 120 is divided into a plurality of buffer blocks 129 by at least one first slit 121 and at least one second slit 122. The difference from the third embodiment is that the first slit(s) 121 extends in an oblique direction of the support surface 123, and the second slit(s) 122 extends in another oblique direction of the support surface 123. For example, the first slit(s) 121 and the second slit(s) 122 may have substantially the same inclination angle relative to the longitudinal direction of the support surface 123. Accordingly, the buffer portion 120 includes a plurality of rhombic and triangular shaped buffer blocks 129 arranged along two intersecting oblique directions. In this way, the buffer portion 120 can effectively disperse the impact force along the two intersecting oblique directions.

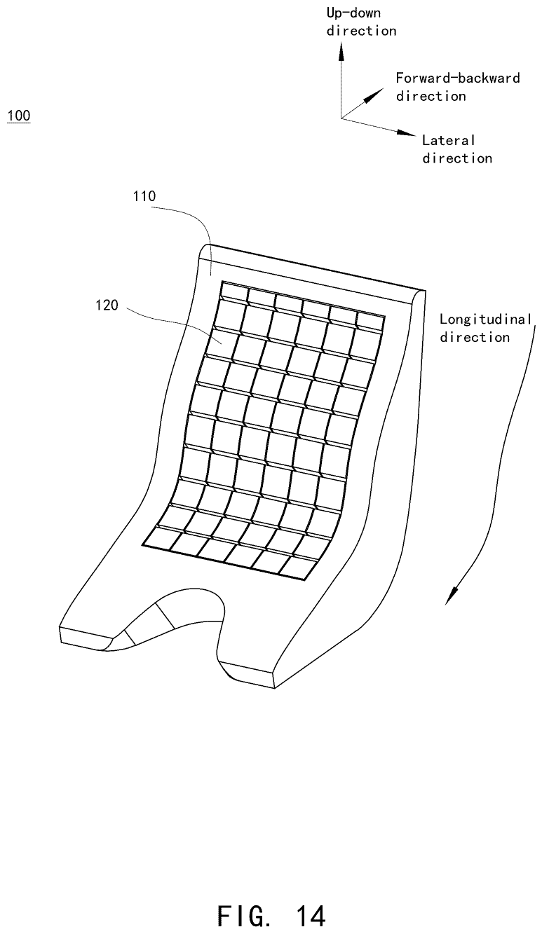

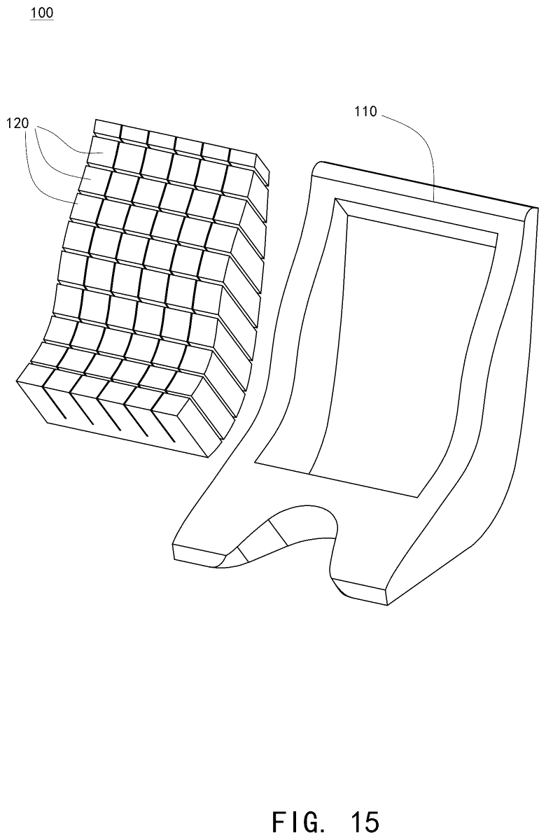

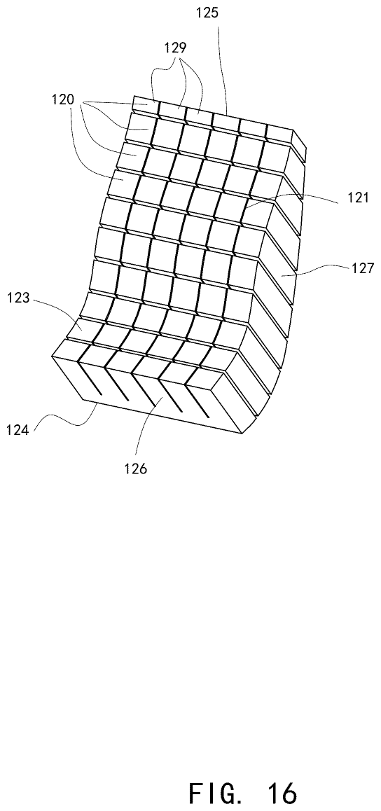

The support structure 100 according to a fifth embodiment of the present application is described with reference to FIGS. 14 to 17.

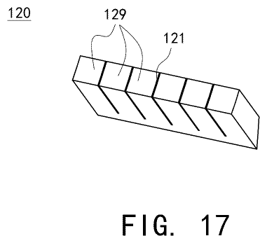

The support structure 100 of the fifth embodiment includes a plurality of buffer portions 120 arranged in parallel within the support body 110. Two adjacent buffer parts 120 may be in contact with each other or have a gap between them. Each buffer portion 120 extends transversely, and the plurality of the buffer portions 120 are arranged along the longitudinal direction of the support surface 123. At least one first slit 121 divides each buffer portion 120 into a plurality of buffer blocks 129. For example, referring to FIG. 17, each buffer portion 120 is in the shape of a transversely extending rectangle, and at least one first slit 121 extending in the longitudinal direction divides the buffer portion 120 into a plurality of buffer blocks 129 arranged in the lateral direction.

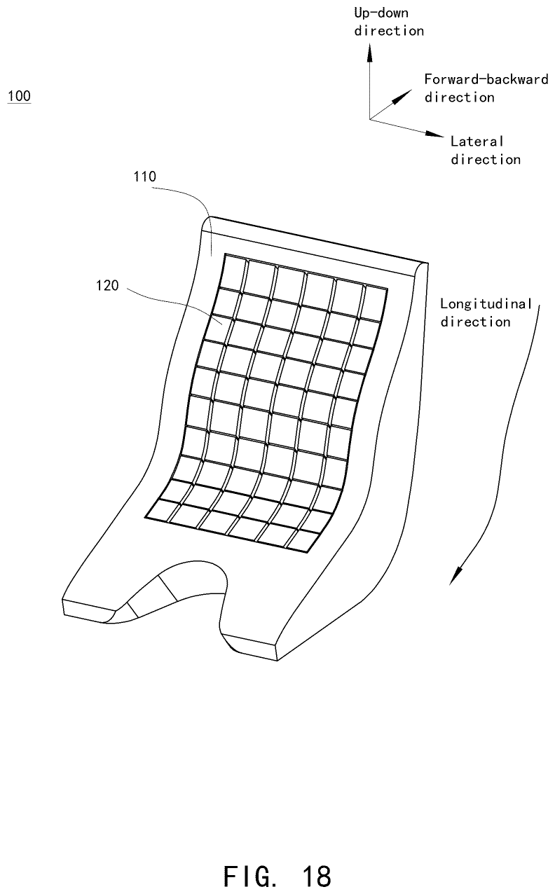

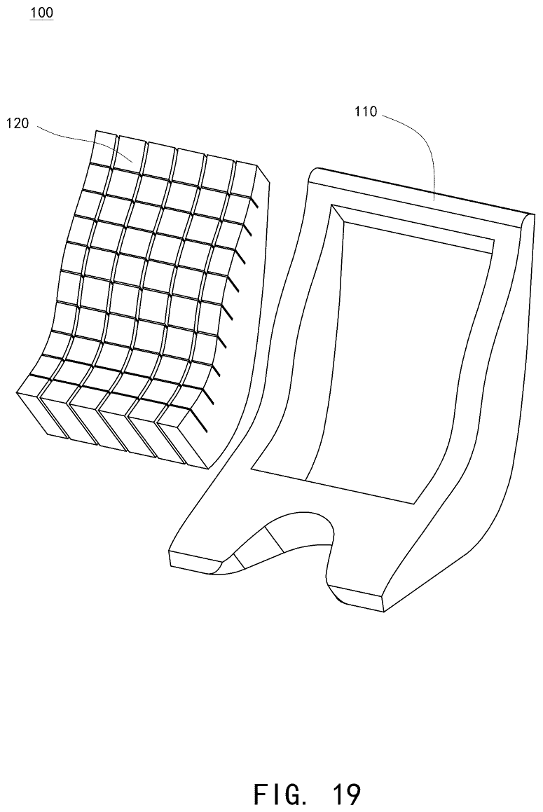

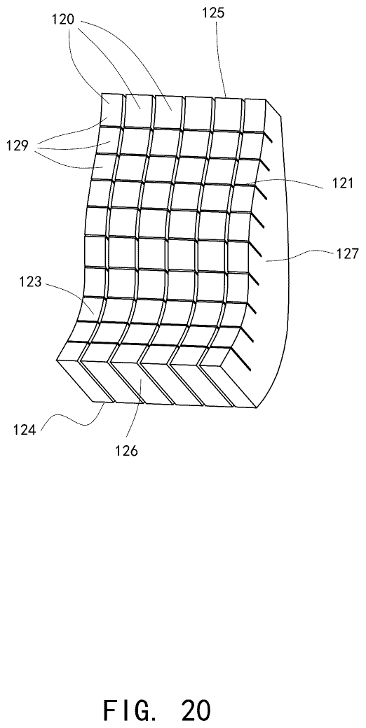

The support structure 100 according to a sixth embodiment of the present application is described with reference to FIGS. 18 to 20.

Similar to the fifth embodiment, the support structure 100 of the sixth embodiment includes a plurality of buffer portions 120. The difference from the fifth embodiment is that each buffer portions 120 in the sixth embodiment extend along the longitudinal direction, and the plurality of the buffer portions 120 are arranged in the lateral direction. At least one first slit 121 extending in the lateral direction divides each buffer portion 120 into a plurality of buffer blocks 129 adjacent in the longitudinal direction.

It should be understood that in other embodiments where multiple buffer portions are included, each buffer portion 120 may also extend in other directions, such as extending in an oblique direction, and the direction of the first slit(s) 121 may also be changed accordingly, as long as the buffer portion 120 can be divided into a plurality of buffer blocks 129.

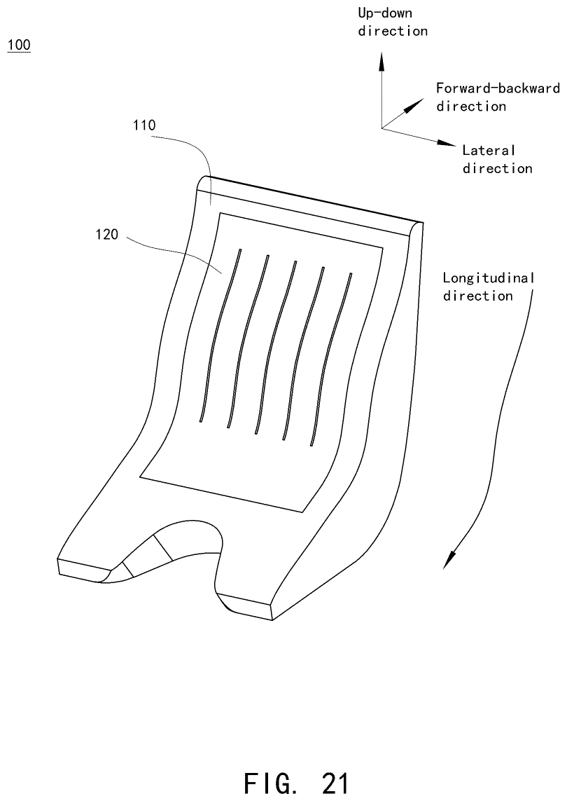

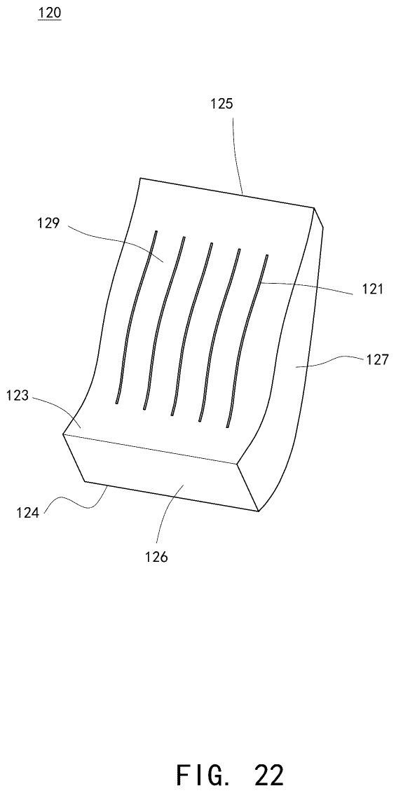

The support structure 100 according to a seventh embodiment of the present application is described with reference to FIGS. 21 to 22.

In the support structure 100 of the seventh embodiment, the first slit(s) 121 penetrates the back surface 124 of the buffer portion 120 opposite the support surface 123, and the buffer blocks 129 are connected to each other at the top surface 125 and the bottom surface 126 of the buffer portion 120. More specifically, each first slit 121 extends along the longitudinal direction and extends from the support surface 123 to the back surface 124. That is, the first slit 121 penetrates the support surface 123 and the back surface 124, so the plurality of buffer blocks 129 divided by the first slit(s) 121 are not connected to each other at the back surface 124.

In this embodiment, the first slit(s) 121 does not penetrate the top surface 125 and the bottom surface 126 of the buffer portion 120, so the buffer blocks 129 may be connected to each other at the top surface 125 and the bottom surface 126. In other embodiments, the first slit(s) 121 may also penetrate one of the top surface 125 or the top surface 125 so that the buffer blocks 129 are connected to each other at the other one. In addition, the plurality of the buffer blocks 129 may also be connected to each other at the top surface 125 and the bottom surface 126 of the buffer portion 120, and at the same time connected to each other at the back surface 124. It should also be understood that the first slit(s) 121 may also extend along the lateral direction and penetrate the support surface 123 and the back surface 124 of the buffer portion 120, so that the buffer blocks 129 are connected to each other at any side surface 127 of the buffer portion 120.

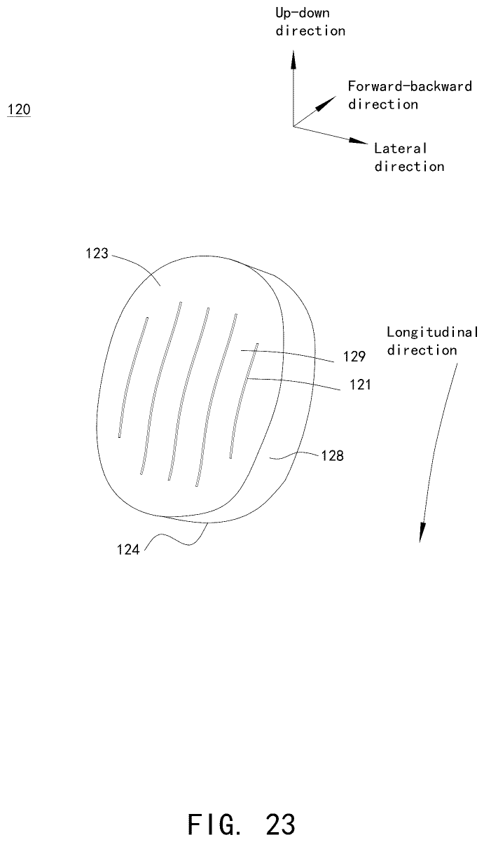

The support structure 100 according to an eighth embodiment of the present application is described with reference to FIG. 23.

In the eighth embodiment, the buffer portion 120 is substantially circular, and at least one first slit 121 penetrates the support surface 123 and the back surface 124 of the buffer portion 120. The buffer blocks 129 divided by the first slit(s) 121 are connected to each other at the periphery 128 of the buffer portion 120. In addition, the plurality of the buffer blocks 129 may also be connected to each other at the periphery 128 and at the back surface 124 of the buffer portion 120.

It should be understood that in various embodiments of the present application, the buffer portion 120 may be circular similar to the eighth embodiment, and the buffer portion 120 may also have other appropriate geometric shapes, such as trapezoid, triangle, octagon, etc., to adapt to the needs of different child safety seats. It should be noted that in the above-mentioned embodiments of the present application, the buffer portion 120 may be detachably connected to the support body 110. For example, the buffer portion 120 is inserted into the accommodating portion 114 so that at least one outermost surface of the buffer portion 120 and an inner surface of the accommodating portion 114 are pressed against each other. The size of the buffer portion 120 may be slightly larger than the size of the accommodating portion 114, so that the buffer portion 120 may be relatively stably positioned within the accommodating portion 114 even if it is not bonded. In addition, the support body 110 is in a frame structure. After the buffer portion 120 is housed in the accommodating portion 114, the buffer portion 120 can be limited all around the frame structure, which also reduces the risk of the buffer portion 120 detaching from the support body 110.

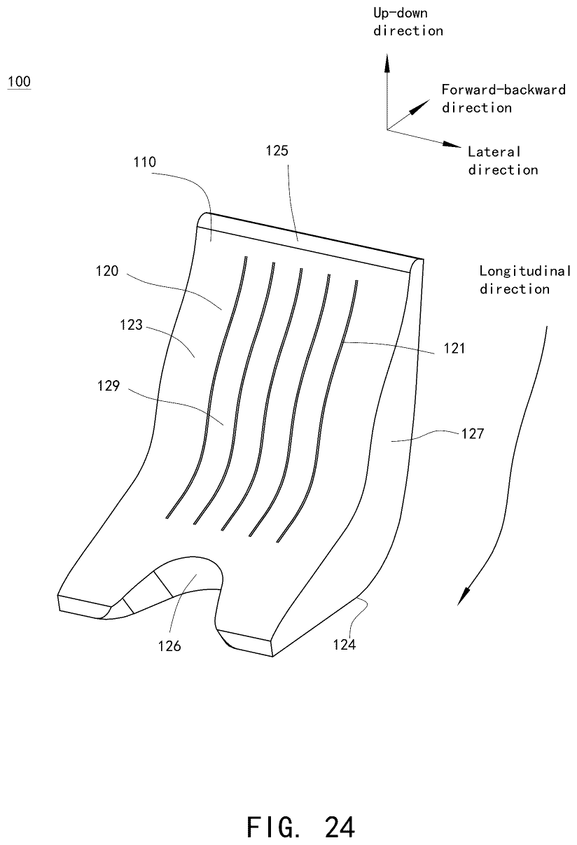

The support structure 100 according to a ninth embodiment of the present application is described with reference to FIG. 24.

In the ninth embodiment, the support body 110 and the buffer portion 120 are integrally formed as a whole. Therefore, the support surface 123, back surface 124, top surface 125, bottom surface 126, and side surfaces 127 of the buffer portion 120 may also be considered as corresponding surfaces of the support body 110. At least one first slit 121 extends along the longitudinal direction and penetrates the support surface 123 and the back surface 124, so the plurality of the buffer blocks 129 are connected to each other at the top surface 125 and the bottom surface 126. It should be understood that in this embodiment, the first slit 121 may also extend in the lateral direction or an oblique direction of the support surface 123.

In various embodiments of the present application, the hardness or density of the buffer portion 120 may be less than or equal to the hardness or density of the support body 110. The hardness of the buffer portion 120 may be between 17 kg/m³ and 29 kg/m³, such as 17 kg/m³, 21 kg/m³ or 29 kg/m³. The hardness of the support body 110 may be between 32 kg/m³ and 40 kg/m³, such as 32 kg/m³, 37 kg/m³ or 40 kg/m³.

In various embodiments of the present application, the buffer portion 120 and the support body 110 may be made of different materials. For example, the buffer portion 120 is made of foam, and the support body 110 is made of memory foam, latex or silicone. In addition, in various embodiments of the present application, the buffer part 120 and the support body 110 may be made of the same material. It should be understood that the buffer portion 120 is divided into a plurality of buffer blocks 129 and the plurality of the buffer blocks 129 are connected to each other. Compared with not being divided, the support structure 100 of the present application can increase the amount of buffering deformation when it is subjected to an impact force, and also facilitates the molding of the support structure 100 (For example, when the buffer portion 120 and the support body 110 are separate structures and are installed with each other to form the support structure 100, since the plurality of the buffer blocks 129 are connected to each other, it may be convenient to mount each buffer portion 120 integrally into the support member 110; when the buffer portion 120 and the support body 110 are of an integrated construction, the installation process can be further reduced).

It should be noted that respective structures in the support structure 100 may be adjusted comprehensively to achieve the desired support force and amount of buffering deformation. For example, compared with the situation where the plurality of the buffer blocks 129 are not connected at the back surface and the first slit(s) 121 penetrates the back surface 124, a greater support force can be provided when the plurality of the buffer blocks 129 are connected to each other at the back surface 124, then the amount of buffering deformation of the support structure 100 can be compensated by increasing the number of the buffer blocks 129, increasing the depth of the first slit(s) 121, or increasing the gap between two adjacent buffer blocks 129, etc. For another example, compared with the situation where the plurality of the buffer blocks 129 are connected to each other at the back surface 124, a better amount of buffering deformation can be provided when the first slit(s) 121 penetrates the back surface 124, at the same time, the support force of the support structure 100 can be compensated by reducing the number of the buffer blocks 129 or shortening the distance between two adjacent buffer blocks 129, etc.

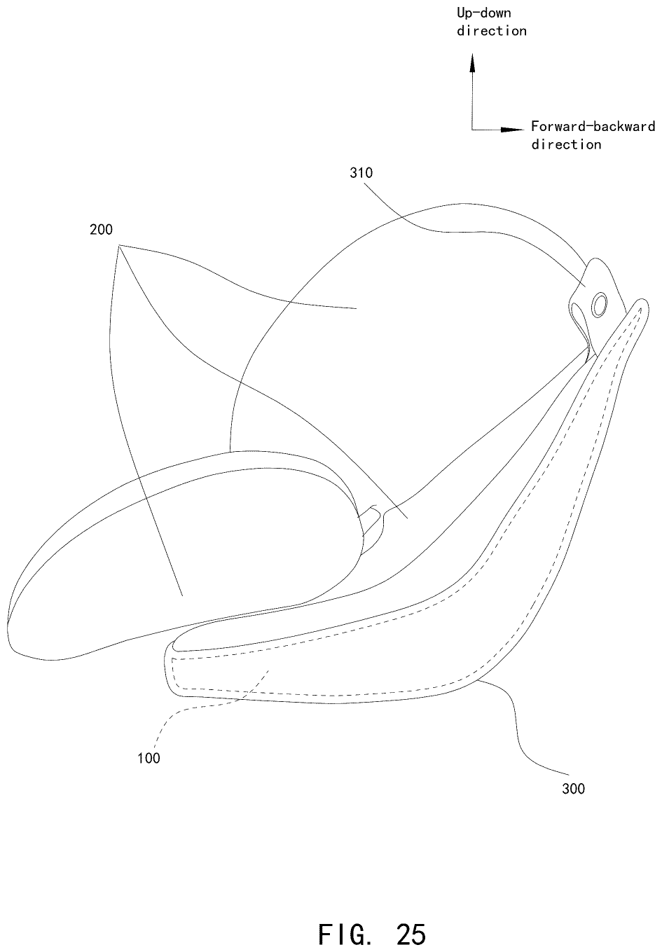

The seat cushion structure according to the present application is described with reference to FIG. 25.

The seat cushion structure includes a seat cushion 200, a support structure 100, and a cover member 300. The seat cushion 200 and cover member 300 are located on the support surface 123 of the support structure 100. The cover member 300 wraps the support structure 100 or at least covers the support surface 123 of the support structure 100. The seat cushion 200 is connected to the cover member 300, for example to a connector 310 at a top end of the cover member 300. The connector 310 may be a button, a buckle, a Velcro, etc.

The seat cushion structure of the present application may be mounted to a child safety seat (not shown). The structure of the child safety seat may refer to the conventional design in the field, which includes a seat body, and the seat body includes a sitting portion and a backrest portion. The seat cushion structure according to the present application is mounted in a corner portion formed by the sitting portion and the backrest portion.

Although preferred embodiments have been shown and described herein, it should be understood that these embodiments are given as examples only. Many modifications, changes and substitutions will occur to those skilled in the art without departing from the spirit of the disclosure. Accordingly, the appended claims are intended to cover all such modifications that fall within the spirit and scope of the present disclosure.

What is claimed is:

1. A support structure, wherein the support structure comprises:
a support body; and
at least one buffer portion, provided within the support body, wherein the buffer portion comprises a plurality of buffer blocks provided adjacent to each other;
wherein at least one first slit is provided on a support surface of the buffer portion, the first slit divides the buffer portion into the plurality of the buffer blocks, and the plurality of the buffer blocks are connected to each other at least one position of the buffer portion other than the support surface.

2. The support structure according to claim 1, wherein,
the plurality of the buffer blocks are connected to each other at least at a back surface of the buffer portion opposite the support surface.

3. The support structure according to claim 1, wherein,
the first slit penetrates a back surface of the buffer portion opposite the support surface, and the buffer blocks are connected to each other at a top surface, a bottom surface, a side surface or periphery of the buffer portion.

4. The support structure according to claim 1, wherein,
the adjacent buffer blocks respectively form cross sections facing and in contact with each other through the first slit.

5. The support structure according to claim 1, wherein,
the adjacent buffer blocks respectively form cross sections facing each other through the first slit, and a gap exists between adjacent cross sections.

6. The support structure according to claim 1, wherein,
a plurality of the first slits extend in a longitudinal direction of the support surface and are arranged along a lateral direction of the support surface; or
the plurality of the first slits extend in the lateral direction of the support surface and are arranged along the longitudinal direction of the support surface.

7. The support structure according to claim 1, wherein,
at least one second slit is provided on the support surface, and the second slit intersects the first slit

8. The support structure according to claim 7, wherein,
the first slit extends in a longitudinal direction of the support surface, and the second slit extends in a lateral direction of the support surface.

9. The support structure according to claim 7, wherein,
the first slit extends in an oblique direction of the support surface, and the second slit extends in another oblique direction of the support surface.

10. The support structure according to claim 1, wherein,
the support body and the buffer portion are integrally formed as a whole.

11. The support structure according to claim 1, wherein,
a plurality of the buffer portions are provided in parallel within the support body.

12. The support structure according to claim 11, wherein,
the plurality of the buffer portions are arranged along a longitudinal direction of the support surface, and each of the buffer portions comprises at least one first slit extending along the longitudinal direction of the support surface; or
the plurality of the buffer portions are arranged along a lateral direction of the support surface, and each of the buffer portions comprises at least one first slit extending along the lateral direction of the support surface.

13. The support structure according to claim 1, wherein,
the support body comprises an accommodating portion for accommodating the buffer portion, the accommodating portion penetrates the support body in a direction orthogonal to the support surface, and the support body is of a frame structure.

14. The support structure according to claim 1, wherein,
the buffer portion comprises:
the support surface, wherein a middle portion of the support surface in a longitudinal direction protrudes forwardly, and a bottom end of the support surface is bent forward;
a back surface, wherein the back surface is opposite to the support surface, and a bottom end of the back surface is bent forward;
a top surface, wherein the top surface is inclined backward and downward;
a bottom surface, wherein the bottom surface is opposite to the top surface, the bottom surface is inclined backward and downward, and the bottom surface is larger than the top surface; and
two side surfaces, wherein the two side surfaces are opposite to each other and flat.

15. The support structure according to claim 14, wherein,
a thickness of the buffer portion at the top surface is less than a thickness of the buffer portion at the bottom surface.

16. The support structure according to claim 1, wherein,
a hardness or density of the buffer portion is less than or equal to a hardness or density of the support body.

17. The support structure according to claim 1, wherein,
a hardness of the buffer portion is between 17 kg/m³ and 29 kg/m³, and a hardness of the support body is between 32 kg/m³ and 40 kg/m³.

18. The support structure according to claim 1, wherein,
the buffer portion is made of foam, and the support body is made of memory foam, latex or silicone.

19. A seat cushion structure, wherein the seat cushion structure comprises:
a seat cushion;
the support structure according to claims 1; and
a cover member, wherein the seat cushion is connected to the cover member, and the seat cushion and cover member are located on the support surface of the support structure.

20. A child safety seat, wherein the child safety seat comprises:
a seat body comprising a sitting portion and a backrest portion; and
the seat cushion structure according to claim 19, mounted in a corner portion formed by the sitting portion and the backrest portion.
